(19) United States
(12) Patent Application Publication
(10) Pub. No.: US 2018/0173470 A1
(43) Pub. Date: Jun. 21, 2018

(54) PRINT RELAY SERVER, METHOD FOR GIVING PRINT COMMAND, AND NON-TRANSITORY RECORDING MEDIUM STORING COMPUTER READABLE PROGRAM

(71) Applicant: KONICA MINOLTA, INC., Tokyo (JP)

(72) Inventor: Hiroaki MAEKAWA, Kawanishi-shi (JP)

(73) Assignee: KONICA MINOLTA, INC., Tokyo (JP)

(21) Appl. No.: 15/834,226

(22) Filed: Dec. 7, 2017

(30) Foreign Application Priority Data
Dec. 15, 2016 (JP) 2016-243128

(51) Int. Cl. G06F 3/12; H04N 1/00

(52) U.S. Cl. CPC G06F 3/126; G06F 3/1222; G06F 3/1288; H04N 2201/0093; H04N 1/00854; H04N 1/00244; H04N 2201/0086; G06F 3/1238

(57) ABSTRACT

A print relay server is provided which performs processing for causing one or more image forming apparatuses to print a document sent by a transmission device. That one or more image forming apparatuses are located in a second organization which a second person is in. The transmission device is located in a first organization which a first person is in and is operated by the first person. The print relay server includes a hardware processor; and a communication unit; wherein the communication unit receives the document from the transmission device, and, where the first person and the second person are correlated with each other, the hardware processor causes the communication unit to send command data indicating a command to print the document to, among that one or more image forming apparatuses, a destination image forming apparatus used by the second person.

The entire disclosure of Japanese Patent application No. 2016-243128, filed on Dec. 15, 2016, is incorporated herein by reference in its entirety.

### BACKGROUND

### 1. Technological Field

The present invention relates to a technology with which an image forming apparatus is caused to print a document through a server.

### 2. Description of the Related Art

Image forming apparatuses called “multifunction devices” or “Multi-Functional Peripherals (MFP)” have attained widespread use. Such an image forming apparatus is connected to a terminal, e.g., a personal computer, via a network, so that the image forming apparatus can execute a print job in response to a command given from the terminal. Alternatively, the image forming apparatus is sometimes connected to another image forming apparatus via a network to execute a print job. The image forming apparatus is also capable of executing a print job given by another image forming apparatus installed in a same/different building of the same company as that of the subject image forming apparatus. The image forming apparatus is also capable of executing a print job given by another image forming apparatus installed in a building of a company different from the company in which the subject image forming apparatus is installed. As such a technology for issuing a command to execute a print job from an image forming apparatus to another image forming apparatus, the following technology has been proposed.

An address list management apparatus stores, for each user of a multifunction machine, an address list that lists pieces of address information for transmission of image data by the multifunction machine. When instructed by a logged-in user to transmit image data, the multifunction machine transmits a request for an address list that specifies the user to the address list management apparatus. Upon receiving the request, the address list management apparatus transmits an address list for transmission pertaining to the user to the multifunction machine. The address list for transmission is created by deleting secret information for each piece of address information from the address list, and modifying such pieces of address information so that image data is transmitted to the address list management apparatus. The address list management apparatus refers to the address list, and transfers the image data to another multifunction machine which is the specified address device. (English abstract of Japanese Laid-open Patent Publication No. 2009-048552).

According to the technology described in Japanese Laid-open Patent Publication No. 2009-048552, where the address list management apparatus stores information indicating a destination of a multifunction machine of a certain organization, the multifunction machine is sometime instructed to print a document by a multifunction machine of another organization. If the document is not necessary for the certain organization, consumables such as paper and toner are excessively consumed for printing the document, or, a job supposed to be executed cannot be executed while the unnecessary document is printed. This is disadvantageous to the certain organization.

### Summary

The present invention has been achieved in light of such a problem, and therefore, an object of an embodiment of the present invention is to reliably prevent an image forming apparatus of a certain organization from printing an unnecessary document sent by another organization as compared to the conventional technologies.

To achieve at least one of the abovementioned objects, according to an aspect of the present invention, a print relay server reflecting one aspect of the present invention is a print relay server for performing processing for causing one or more image forming apparatuses to print a document sent by a transmission device, that one or more image forming apparatuses being located in a second organization which a second person is in, the transmission device being located in a first organization which a first person is in and being operated by the first person. The print relay server includes a hardware processor; and a communication unit; wherein the communication unit receives the document from the transmission device, and, where the first person and the second person are correlated with each other, the hardware processor causes the communication unit to send command data indicating a command to print the document to, among that one or more image forming apparatuses, a destination image forming apparatus used by the second person.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an example of the overall configuration of a document delivery system.

FIG. 2 is a diagram showing an example of the hardware configuration of an image forming apparatus.

FIG. 3 is a diagram showing an example of the hardware configuration of a print server.

FIG. 4 is a diagram showing an example of the functional configuration of a print server.

FIG. 5 is a diagram showing an example of the functional configuration of a business card management server.

FIG. 6 is a diagram showing an example of first business card data and second business card data.

FIG. 7 is a diagram showing an example of affiliation data.

FIG. 8 is a diagram showing an example of device data.

FIG. 9 is a diagram showing an example of choice data.

FIG. 10 is a flowchart depicting an example of the flow of processing for registering a destination device.

FIG. 11 is a diagram showing an example of a registration web page.

FIG. 12 is a flowchart depicting an example of the flow of processing for registering a destination user.

FIG. 13 is a diagram showing an example of a registration web page.

FIGS. 14A and 14B are diagrams showing an example of a login record table and a job record table, respectively.

FIG. 15 is a flowchart depicting an example of the flow of processing for cloud printing.

FIG. 16 is a diagram showing an example of a print command page.

FIG. 17 is a flowchart depicting an example of the flow of the entire processing based on a cloud print program.

FIG. 18 is a flowchart depicting an example of the flow of the entire processing based on a business card management program.

FIG. 19 is a diagram showing an example of transmission log data.

FIGS. 20A and 20B are diagrams showing an example of an electronic mail message and a selection page.

### DETAILED DESCRIPTION OF THE EMBODIMENTS

Hereinafter, one or more embodiments of the present invention will be described with reference to the drawings. However, the scope of the invention is not limited to the disclosed embodiments.

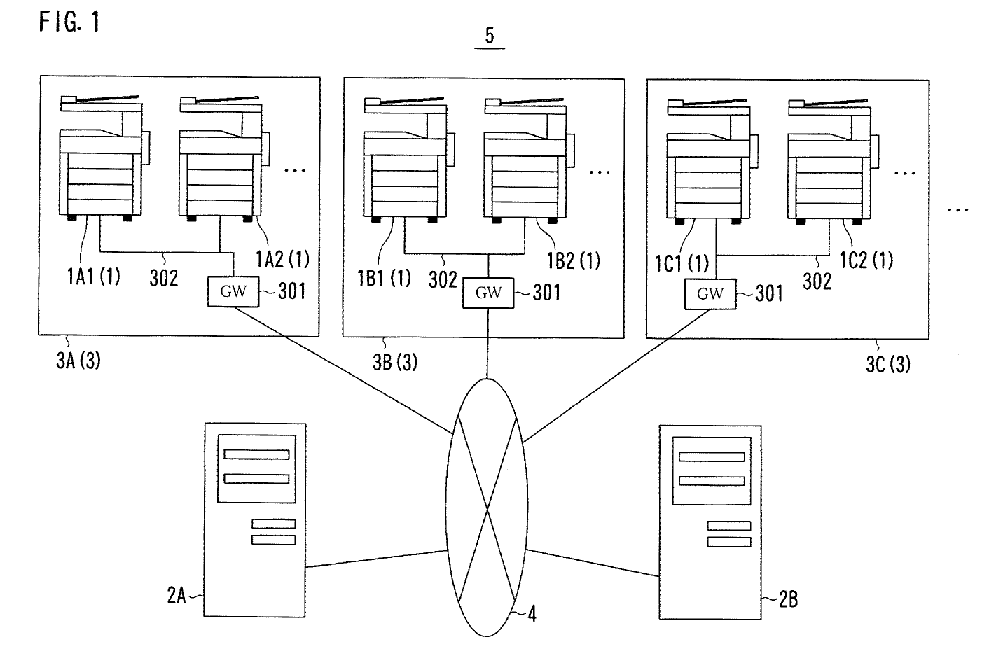

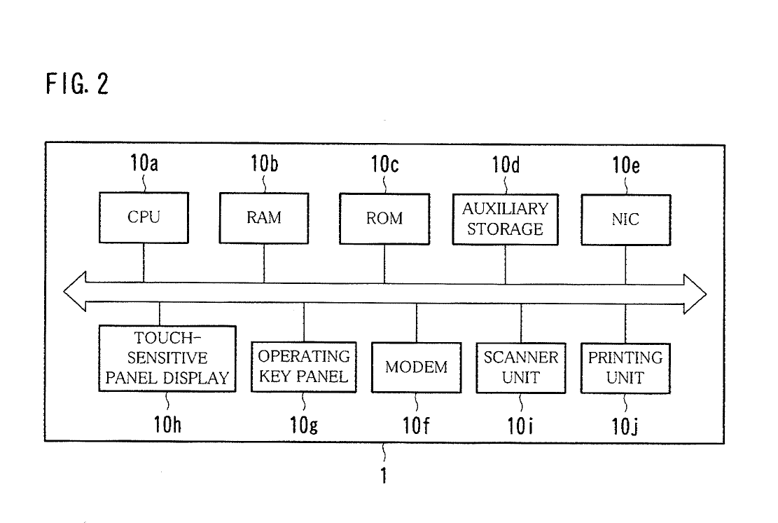

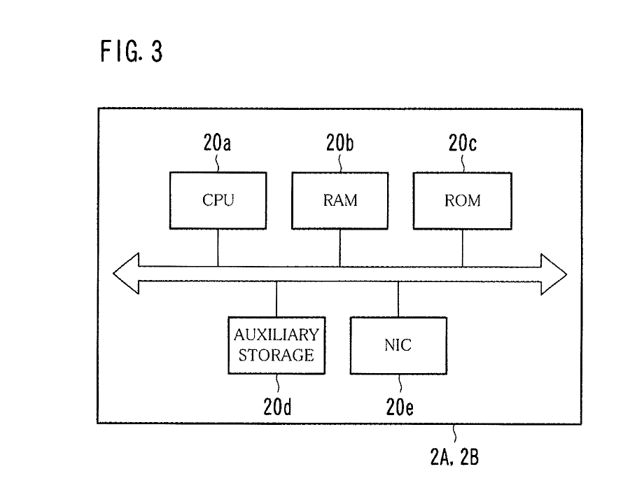

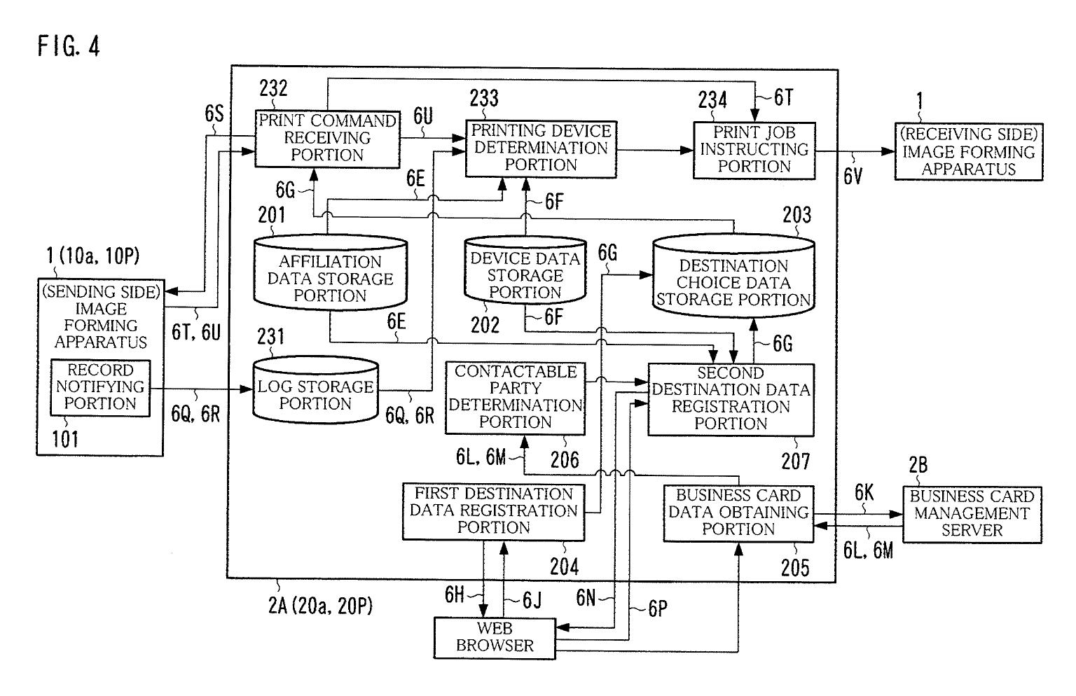

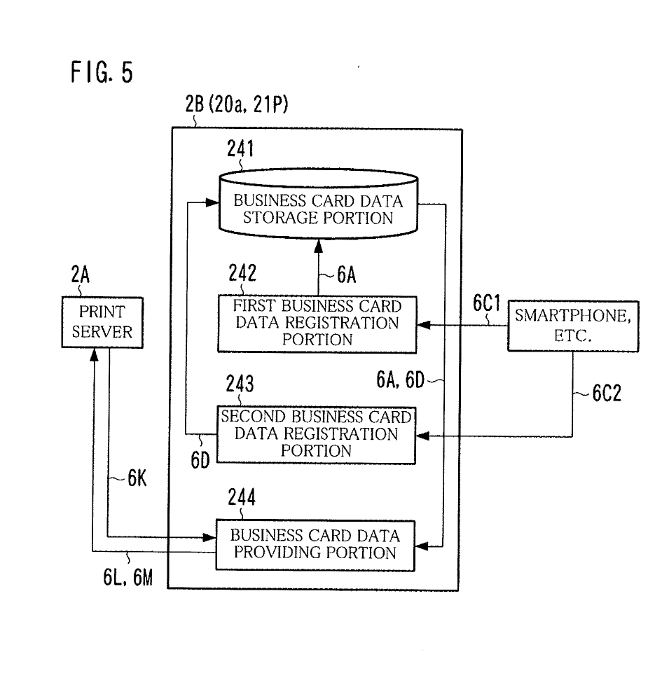

FIG. 1 is a diagram showing an example of the overall configuration of a document delivery system 5. FIG. 2 is a diagram showing an example of the hardware configuration of an image forming apparatus 1. FIG. 3 is a diagram showing an example of the hardware configuration of a print server 2A. FIG. 4 is a diagram showing an example of the functional configuration of the print server 2A. FIG. 5 is a diagram showing an example of the functional configuration of a business card management server 2B.

The document delivery system 5 is to assist two users in delivering a document including an image such as a text, photo, picture, or chart. The document delivery system 5 permits two users of the same organization to send/receive a document therebetween. Further, where predetermined conditions are satisfied, the document delivery system 5 permits two users of different organizations to send/receive a document therebetween.

Referring to FIG. 1, the document delivery system 5 is configured of the print server 2A, the business card management server 2B, a plurality of local area networks 3, a communication line 4, and so on.

Each of the local area networks 3 is configured of one or more image forming apparatuses 1, a gateway 301, a communication line 302, and so on. The image forming apparatuses 1 and the gateway 301 are capable of performing communication with one another via the communication line 302. The communication line 302 is configured of a hub, a twisted pair cable, and so on.

The local area network 3 is installed for each facility of an organization such as a corporation, a government office, or a school. In some cases, an organization which is a tenant of a building installs the local area network 3 in a room of the building. In other cases, the organization installs the local area network 3 in the entirety of the building owned by the organization. While an organization has one local area network 3 in some cases, an organization has a plurality of local area networks 3 in other cases.

The gateway 301 serves to relay a communication between a device of the local area network 3 (the image forming apparatus 1, for example) and a device external to the local area network 3 (the print server 2A, for example) via both the communication line 302 and the communication line 4. Examples of the gateway 301 include a router. Examples of the communication line 4 include the Internet and a dedicated line.

Hereinafter, the local area networks 3 may be stated by respectively differentiating them as a “local area network 3A”, a “local area network 3B”, a “local area network 3C”, . . . , and so on.

Each of the users is given a unique user code in advance. Each of the organizations is given a unique organization code in advance.

The image forming apparatus 1 is generally called a “multifunction device” or a “Multi-Functional Peripheral (MFP)”. The image forming apparatus 1 is an apparatus into which functions such as copying, network printing, scanning, faxing, and cloud printing are consolidated.

The “network printing function” is to receive data on a document sent by a terminal such as a personal computer, a tablet computer, or a smartphone provided in the local area network 3 in which the image forming apparatus 1 is provided to print the document onto paper based on the data. The network printing function is sometimes called “network print” or “PC printing”.

The “cloud printing function” is to receive data on a document from an external device via a server over the Internet to print the document onto paper. In this embodiment, the data is received through the print server 2A.

Referring to FIG. 2, the image forming apparatus 1 is configured of a Central Processing Unit (CPU) 10a, a Random Access Memory (RAM) 10b, a Read Only Memory (ROM) 10c, an auxiliary storage 10d, a Network Interface Card (NIC) 10e, a modem 10f, an operating key panel 10g, a touch-sensitive panel display 10h, a scanner unit 10i, a printing unit 10j, and so on.

The NIC 10e performs communication with the print server 2A or a terminal in accordance with a protocol such as Transmission Control Protocol/Internet Protocol (TCP/IP).

The modem 10f sends and receives document data with a facsimile terminal in accordance with a protocol such as G3.

The NIC 10e and the modem 10f constitute a communication unit. Where another communication device is provided in the image forming apparatus 1, that another communication device is also included in the communication unit.

The operating key panel 10g has keys for operation such as numeric keys, a start key, and a stop key.

The touch-sensitive panel display 10h displays, for example, a screen for presenting messages to a user, a screen for showing the results of processing, a screen for allowing the user to input commands to the image forming apparatus 1. The touch-sensitive panel display 10h detects a touched location to inform the CPU 10a of the touched location.

The user operates the operating key panel 10g or the touch-sensitive panel display 10h to give a command or enter data into the image forming apparatus 1.

The scanner unit 10i optically reads a document recorded on paper to generate image data thereof.

The printing unit 10j prints, onto paper, a document captured by the scanner unit 10i and a document indicated in image data sent by the print server 2A, a terminal, or a fax terminal.

The ROM 10c or the auxiliary storage 10d stores, therein, a program such as an operating system and an application for implementing the foregoing functions. In particular, as a program for the cloud printing function, the ROM 10c or the auxiliary storage 10d stores a web browser program therein.

The ROM 10c or the auxiliary storage 10d also stores, therein, a record notifying program 10P. The record notifying program 10P is to inform the print server 2A of a login record and a job record.

The programs are loaded into the RAM 10b as necessary, and are executed by the CPU 10a. The auxiliary storage 10d is, for example, a hard disk drive or a Solid State Drive (SSD).

Hereinafter, in all of the image forming apparatuses 1, the image forming apparatuses 1 located in the local area network 3A are sometimes referred to as an “image forming apparatus 1A1”, an “image forming apparatus 1A2”, . . . , and so on. In all of the image forming apparatuses 1, the image forming apparatuses 1 located in the local area network 3B are sometimes referred to as an “image forming apparatus 1B1”, an “image forming apparatus 1B2”, . . . , and so on. In all of the image forming apparatuses 1, the image forming apparatuses 1 located in the local area network 3C are sometimes referred to as an “image forming apparatus 1C I”, an “image forming apparatus 1C2”, . . . and so on.

The print server 2A is a cloud print server. The print server 2A causes the image forming apparatus 1 designated by the user to print a document prepared in a personal computer, a tablet computer, or a smartphone.

Examples of the print server 2A include a so-called server machine or a cloud server. Hereinafter, an example is described in which the print server 2A is a server machine.

Referring to FIG. 3, the print server 2A is configured of a CPU 20a, a RAM 20b, a ROM 20c, an auxiliary storage 20d, an NIC 20e, and so on.

The NIC 20e performs communication with the image forming apparatus 1, the business card management server 2B, and so on in accordance with a protocol such as TCP/IP.

The ROM 20c or the auxiliary storage 20d stores, therein, a cloud print program 20P as a program for client print server. The cloud print program 20P implements the functions of an affiliation data storage portion 201, a device data storage portion 202, a destination choice data storage portion 203, a first destination data registration portion 204, a business card data obtaining portion 205, contactable party determination portion 206, a second destination data registration portion 207, a log storage portion 231, a print command receiving portion 232, a printing device determination portion 233, a print job instructing portion 234, and so on, all of which are shown in FIG. 4.

The business card management server 2B serves to manage information on users of the document delivery system 5 and information on persons related to the users. The information is the one usually included in a business card. The information includes a name, an organization name of an organization which the corresponding user/person is in, a department name, an address, a telephone number, and a fax number.

The business card management server 2B is, for example, a so-called server machine or a cloud server. Hereinafter, an example is described in which the business card management server 2B is a server machine.

The hardware configuration of the business card management server 2B is basically the same as that of the print server 2A as shown in FIG. 3.

It is noted, however, that the ROM 20c or the auxiliary storage 20d stores a business card management program 21P therein. The business card management program 21P implements the functions of a business card data storage portion 241, a first business card data registration portion 242, a second business card data registration portion 243, a business card data providing portion 244, and so on, all of which are shown in FIG. 5.

The description goes on to processing by the individual portions of the print server 2A shown in FIG. 4, processing by the individual portions of the business card management server 2B shown in FIG. 5, and processing by the image forming apparatus 1.

[Managing and Registering Data]

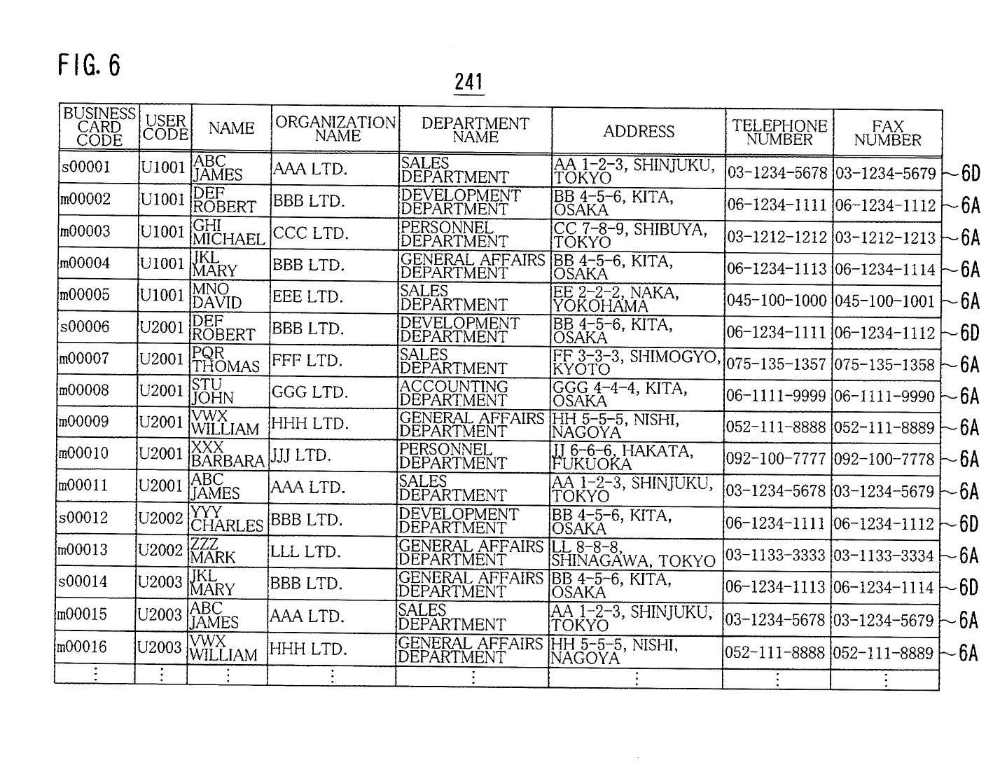

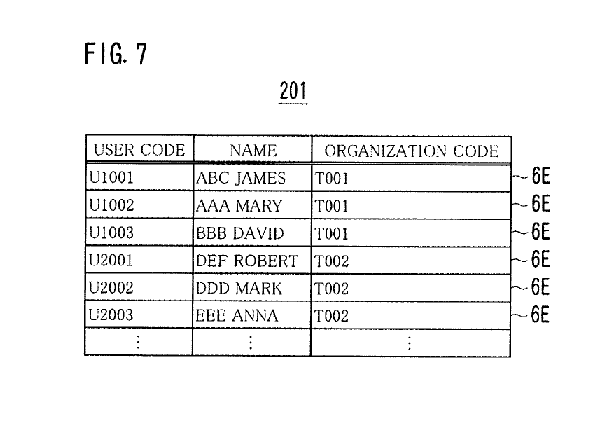

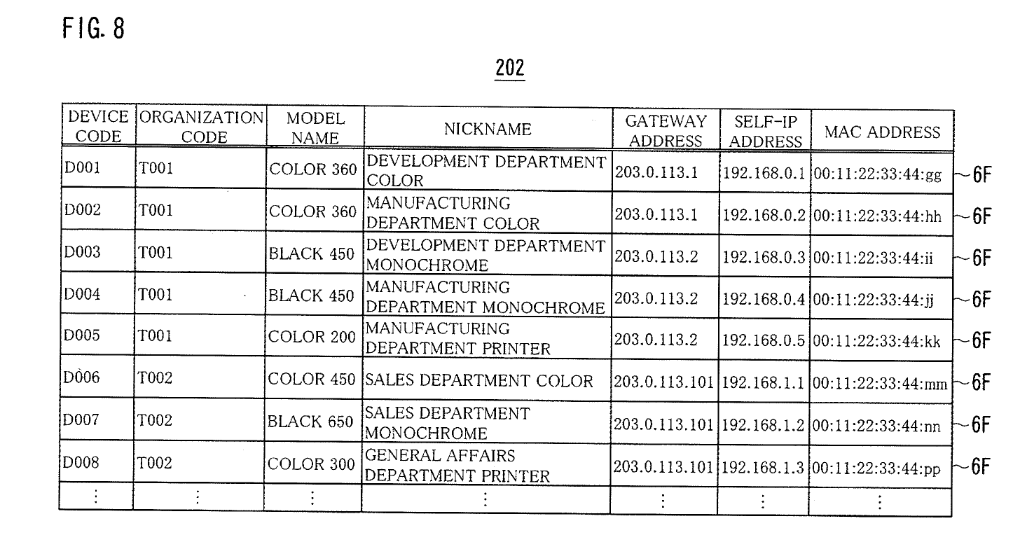

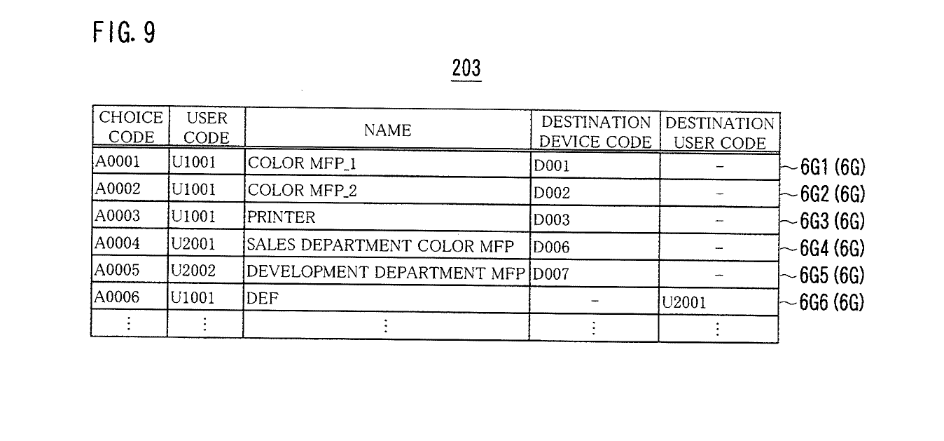

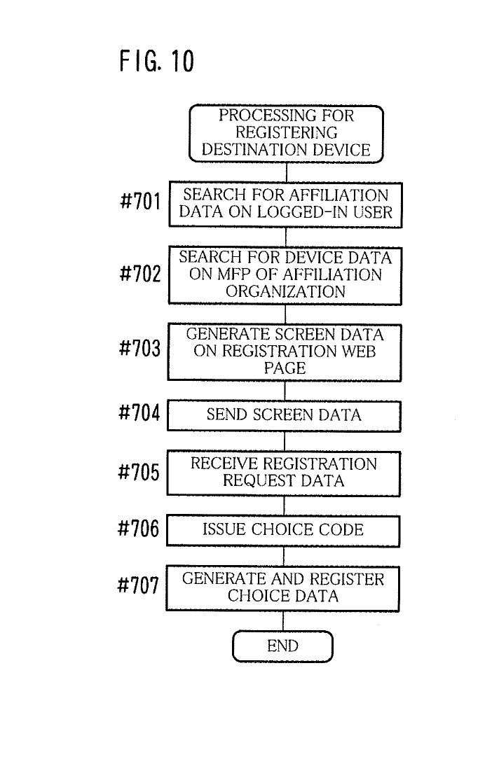

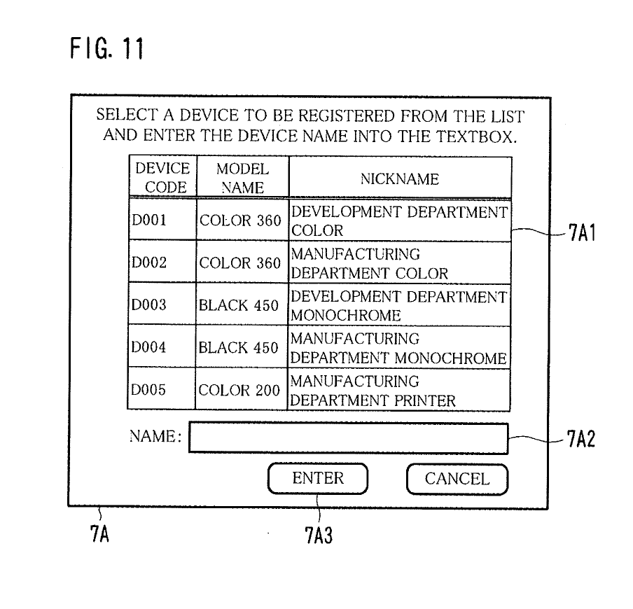

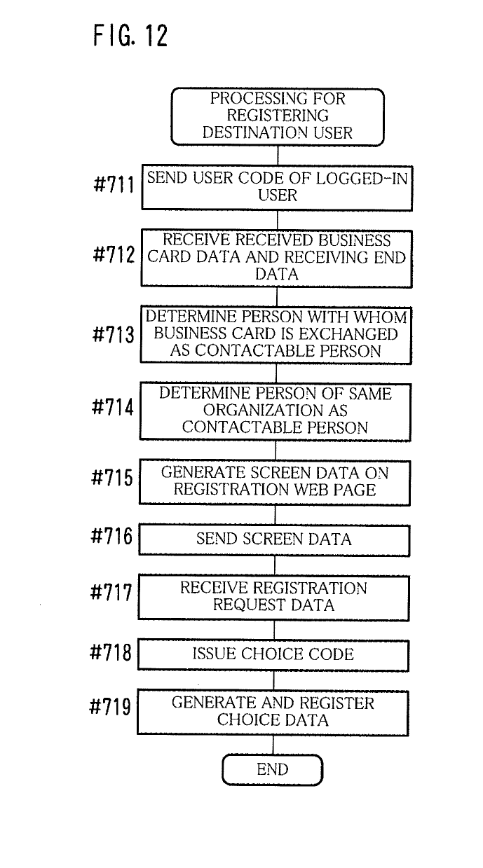

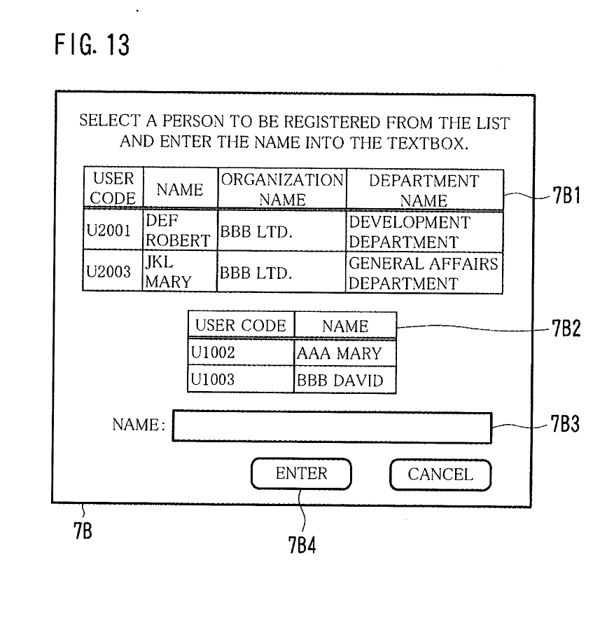

FIG. 6 is a diagram showing an example of first business card data 6A and second business card data 6D. FIG. 7 is a diagram showing an example of affiliation data 6E. FIG. 8 is a diagram showing an example of device data 6F. FIG. 9 is a diagram showing an example of choice data 6G. FIG. 10 is a flowchart depicting an example of the flow of processing for registering a destination device. FIG. 11 is a diagram showing an example of a registration web page 7A. FIG. 12 is a flowchart depicting an example of the flow of processing for registering a destination user. FIG. 13 is a diagram showing an example of a registration web page 7B.

As shown in FIG. 6, the business card data storage portion 241 of the business card management server 2B stores, therein, the first business card data 6A for each business card received by a user. The first business card data 6A indicates the following information.

The “business card code” is an identifier for identifying the corresponding business card. The initial letter of the business card code is a predetermine letter. The predetermine letter “m” is used in this embodiment.

The “user code” is a user code of a user who has received the corresponding business card. The “name” is a name described in the corresponding business card. In other words, the name shows a name of a person who has given the corresponding business card to the user.

The “organization name” is a name of an organization which the person is in. The “department name” is a name of a department which the person works in. The “address”, the “telephone number”, and the “fax number” indicate an address, a telephone number, and a fax number of the organization or the department, respectively. These pieces of information are described also in the corresponding business card.

The first business card data 6A is created by the first business card data registration portion 242 and stored into the business card data storage portion 241 as discussed below.

When receiving a business card from a person, the user uses a smartphone or a tablet computer to perform the following task. To be specific, the user takes an image of a printed side of the business card of the person. Thereby, image data 6B1 on the business card is created. The user composes a first electronic mail message 6C1 by writing, in the body of the message, his/her user code and a command to register the business card received, and attaching the image data 6B1 to the first electronic mail message 6C1. The user then sends the first electronic mail message 6C to the business card management server 2B.

The first business card data registration portion 242 receives the first electronic mail message 6C1 to apply, to the image data 6B1, a known method for extracting the information from the image of the business card. In this way, a name of the person, an organization name, a department name, an address, a telephone number, a fax number, and so on are extracted.

The first business card data registration portion 242 issues a unique business card code starting with the letter “m”. The first business card data registration portion 242 then generates data which indicates the business card code thus issued, the user code contained in the body of the first electronic mail message 6C1, and the information extracted. The first business card data registration portion 242 then stores the generated data, as the first business card data 6A, into the business card data storage portion 241.

The business card data storage portion 241 also stores, therein, the second business card data 6D on a user-by-user basis. The items of information indicated in the second business card data 6D are the same as those of information indicated in the first business card data 6A.

It is noted, however, that the “user code” and the “name” are a user code and a name of the subject user, respectively. The “organization name” is a name of an organization which the subject user is in. The “department name” is a name of a department which the subject user works in. The “address”, the “telephone number”, and the “fax number” indicate an address, a telephone number, and a fax number of the organization or the department, respectively.

As the initial letter of the business card code, a predetermined letter different from the initial letter of the business card code of the first business card data 6A is used. The predetermine letter “s” is used in this embodiment.

The second business card data 6D is created by the second business card data registration portion 243 and stored into the business card data storage portion 241 as discussed below.

The user uses a smartphone or a tablet computer to perform the following task. To be specific, the user takes an image of a printed side of his/her business card. Thereby, image data 6B2 on the business card is created. The user composes a second electronic mail message 6C2 by writing, in the body of the message, his/her user code and a command to register his/her business card, and attaching the image data 6B2 to the second electronic mail message 6C2. The user then sends the second electronic mail message 6C2 to the business card management server 2B.

The second business card data registration portion 243 receives the second electronic mail message 6C2 to apply, to the image data 6B2, a known method for extracting the information from the image of the business card. In this way, a name of the user, an organization name, a department name, an address, a telephone number, a fax number, and so on are extracted.

The second business card data registration portion 243 issues a unique business card code starting with the letter “s”. The second business card data registration portion 243 then generates data which indicates the business card code thus issued, the user code contained in the body of the second electronic mail message 6C2, and the information extracted. The second business card data registration portion 243 then stores the generated data, as the second business card data 6D, into the business card data storage portion 241.

Where the business card contains an electronic mail address, the second business card data registration portion 243 extracts the electronic mail address to generate the second business card data 6D so as to indicate the same.

With the print server 2A, the affiliation data storage portion 201 stores, therein, the affiliation data 6E in advance on a user-by-user basis as shown in FIG. 7. The affiliation data 6E indicates a user code of the user and an organization code of an organization which the user is in.

Where a new user joins any of the organizations, an administrator registers the affiliation data 6E on the new user to the affiliation data storage portion 201. Where an existing user leaves the organization, the administrator deletes the affiliation data 6E on the user from the affiliation data storage portion 201.

Referring to FIG. 8, the device data storage portion 202 stores, therein, the device data 6F for each of the image forming apparatuses 1 in advance. The device data 6F indicates the following information.

The “device code” is an identifier for the administrator of the document delivery system 5 or the like to identify the corresponding image forming apparatus 1. The “organization code” is an organization code of an organization in which the corresponding image forming apparatus 1 is installed. The “model name” is a name or a model number of a model of the corresponding image forming apparatus 1. The “nickname” is a name which makes it easy for the user to distinguish the corresponding image forming apparatus 1 from the other image forming apparatuses 1.

The “gateway address” is an Internet Protocol (IP) address of the gateway 301 of the local area network 3 in which the corresponding image forming apparatus 1 is located. The “self-IP address” and the “MAC address” are an IP address and a Media Access Control (MAC) address given to the corresponding image forming apparatus 1, respectively.

Where a new image forming apparatus 1 is installed in any of the organizations, the administrator registers the device data 6F on the new image forming apparatus 1 to the device data storage portion 202. Where an existing image forming apparatus 1 is no longer used, the administrator deletes the device data 6F on that image forming apparatus 1 from the device data storage portion 202.

Referring to FIG. 9, the destination choice data storage portion 203 stores, therein, the choice data 6G for each choice selectable as the document destination by the user. In the choice data 6G, the image forming apparatus 1 which is caused to print a document may be set as the destination, and the other party to which the document is to be given may be set as the destination. The choice data 6G indicates the following information.

The “choice code” is an identifier for identifying the corresponding choice data 6G. The “user code” is a user code of a user who is allowed to use the choice data 6G.

The “destination device code” is information used when the image forming apparatus 1 which is caused to print a document is set as the destination. The “destination device code” is a device code of that image forming apparatus 1. The “destination user code” is information used when the other party is set as the destination. The “destination user code” is a user code of that other party. Only any one of the destination device code and the destination user code is shown in the choice data 6G. The “name” is information which makes it easy for the user to distinguish the destination from the other destinations.

The user is allowed to store, in advance, as the choice data 6G, data to be sent to the image forming apparatus 1 installed in his/her organization in the destination choice data storage portion 203. In such a case, the choice data 6G is generated by the first destination data registration portion 204 and is stored into the destination choice data storage portion 203. The description goes on to the flow of the processing by the first destination data registration portion 204. The description is provided with reference to the flowchart of FIG. 10.

The user uses a web browser installed on a tablet computer, a smartphone, or a personal computer to log into the print server 2A with his/her user code. The user then enters a Uniform Resource Locator (URL) of a web page in which to register the image forming apparatus 1 as a destination. The user who has logged into the print server 2A is hereinafter referred to as a “logged-in user”.

The first destination data registration portion 204 searches in (Step #701 of FIG. 10) the affiliation data storage portion 201 (see FIG. 7) for the affiliation data 6E indicating the user code used at the time of the login. The first destination data registration portion 204 then searches in (Step #702) the device data storage portion 202 (see FIG. 8) for the device data 6F indicating the organization code shown in the affiliation data 6E found out by the search. The first destination data registration portion 204 then generates (Step #703), based on the device data 6F found out by the search, the screen data 6H based on which the registration web page 7A as shown in FIG. 11 is displayed and then sends the screen data 6H to the web browser (Step #704).

The web browser receives the screen data 6H to display the registration web page 7A. The logged-in user selects a device code of the image forming apparatus 1 to be registered from a list 7A of the registration web page 7A, and inputs a name to be given to that image forming apparatus 1 to a text box 7A2. The logged-in user then presses an enter button 7A3. In response to the enter button 7A3 pressed, the web browser sends registration request data 63 indicating the device code selected and the name inputted to the print server 2A.

The first destination data registration portion 204 receives the registration request data 6J (Step #705) and issues a unique choice code (Step #706). The first destination data registration portion 204 then generates data which indicates, as the “choice code”, the “user code”, the “name”, and the “destination device code”, the issued choice code, the user code of the logged-in user, the name and the device code indicated in the registration request data 6J, respectively, and stores, as the choice data 6G, the generated data into the destination choice data storage portion 203 (Step #707).

The user can also store, as the choice data 6G, data to be sent to another user into the destination choice data storage portion 203. However, if that another user is in an organization different from that of the logged-in user, then meeting the predetermined conditions is necessary for the registration.

The processing for storing, as the choice data 6G, data to be sent to another user is performed by the business card data obtaining portion 205, the contactable party determination portion 206, the second destination data registration portion 207, and so on as shown in the steps of FIG. 12.

The user uses a web browser installed on the image forming apparatus 1 or a personal computer to log into the print server 2A with his/her user code. The user then enters a URL of a web page in which to register that another user as a destination.

In response to the user operation, the business card data obtaining portion 205 performs processing for obtaining data on a business card from the business card management server 2B in the following manner.

The business card data obtaining portion 205 sends business card request data 6K indicating the user code of the user (logged-in user) to the business card management server 2B (Step #711 of FIG. 12).

With the business card management server 2B, the business card data providing portion 244 receives the business card request data 6K and searches in the business card data storage portion 241 for the first business card data 6A showing the user code indicated in the business card request data 6K. The business card data providing portion 244 sends, as received business card data 6L, the first business card data 6A to the print server 2A. If plurality of sets of first business card data 6A are found out by the search, then the business card data providing portion 244 sends each of the sets of first business card data 6A as the received business card data 6L. In this way, data on the business card that the logged-in user received in the past is sent to the print server 2A.

The business card data providing portion 244 further searches in the business card data storage portion 241 for the second business card data 6D showing the user code indicated in the business card request data 6K. The business card data providing portion 244 searches for the first business card data 6A which indicates the name, the organization name, the department name, the address, the telephone number, and the fax number shown in that second business card data 6D. The business card data providing portion 244 further searches for the second business card data 6D which indicates the user code shown in that first business card data 6A. The business card data providing portion 244 then sends the second business card data 6D, as receiving end data 6M, to the print server 2A. In this way, data on the business card of the person to whom the logged-in user gave his/her business card in the past is sent to the print server 2A.

With the print server 2A, the business card data obtaining portion 205 receives the received business card data 6L and the receiving end data 6M (Step #712).

In response to the receipt of the received business card data 6L and the receiving end data 6M, the contactable party determination portion 206 determines a person with whom the logged-in user can send/receive the document by using the document delivery system 5 in the following manner. Such a person is hereinafter referred to as a “contactable person”.

The contactable party determination portion 206 extracts the received business card data 6L and the receiving end data 6M that are common in the items of name, organization name, department name, address, telephone number, and fax number to determine that a person related to the received business card data 6L or to the receiving end data 6M thus extracted is a contactable person (Step #713). In short, the contactable party determination portion 206 determines that a person with whom the logged-in user has exchanged business cards is a contactable person.

The contactable party determination portion 206 further searches in the affiliation data storage portion 201 for another set of affiliation data 6E showing the organization code indicated in the affiliation data 6E of the logged-in user (see FIG. 7) and determines that a person related to that another set of affiliation data 6E is a contactable person (Step #714). In short, the contactable party determination portion 206 determines that a person of the same organization as that of the logged-in user is a contactable person.

The second destination data registration portion 207 generates screen data 6N (Step #715) for displaying the registration web page 7B as shown in FIG. 13 based on the result of determination by the contactable party determination portion 206, and sends the screen data 6N to the web browser (Step #716). The registration web page 7B has a list 7B1 which is created based on the received business card data 6L of the person determined to be a contactable person in Step #713. The registration web page 7B has a list 7B2 which is created based on the affiliation data 6E of the person who is determined to be a contactable person in Step #714.

The web browser receives the screen data 6N and displays the registration web page 7B. The user selects, on the registration web page 7B, a user code of a person to be registered as the destination from the list 7B1 or the list 7B2 of the registration web page 7B, and enters a name to be given to the person into a text box 7B3. The user then presses an enter button 7B4. In response to the user operation, the web browser sends registration request data 6P indicating the selected user code and the entered name to the print server 2A.

The second destination data registration portion 207 receives the registration request data 6P (Step #717) and issues a unique choice code (Step #718). The second destination data registration portion 207 then generates data indicating, as the “choice code”, the “user code”, the “name”, and the “destination user code”, the choice code issued, the user code of the user who logs in the print server 2A, the name and the user code shown in the registration request data 6P, to store the generated data into the destination choice data storage portion 203 as the choice data 6G (Step #719).

[Managing Log]

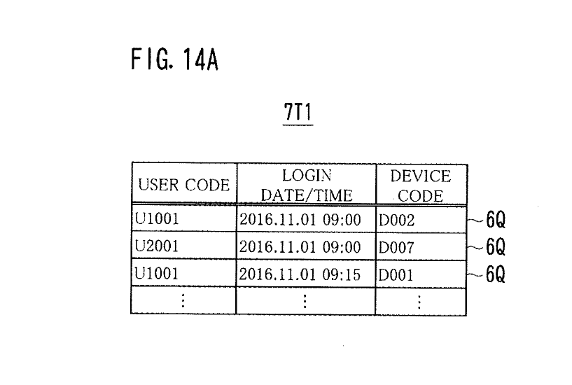

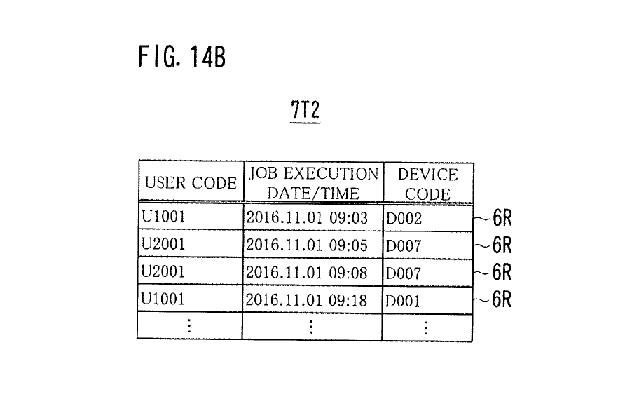

FIGS. 14A and 14B are diagrams showing an example of a login record table 7T1 and a job record table 7T2, respectively.

The record notifying program 10P implements the record notifying portion 101 in the image forming apparatus 1 (see FIG. 4).

The record notifying portion 101 informs the print server 2A of a record of login by the user into the image forming apparatus 1 and a record of job execution.

To be specific, every time the user logs into the image forming apparatus 1, the record notifying portion 101 generates login record data 6Q indicating a user code of the user, a date and time at which the user logs into the image forming apparatus 1 (login date/time), and a device code of the subject image forming apparatus 1, and sends the login record data 6Q to the print server 2A.

Alternatively, every time a job is executed, the record notifying portion 101 generates job record data 6R indicating the user code of the logged-in user (namely, user who has given the job command), a date and time at which the job has been executed, and the device code of the subject image forming apparatus 1, and sends the job record data 6R to the print server 2A.

With the print server 2A, the log storage portion 231 has the login record table 7T1 as that shown in FIG. 14A and the job record table 7T2 as that shown in FIG. 14B. Every time receiving the login record data 6Q, the log storage portion 231 stores the login record data 6Q into the login record table 771. Every time receiving the job record data 6R, the log storage portion 231 stores the job record data 6R into the job record table 7T2.

The record notifying portion 101 may send the job record data 6R with the job type limited. For example, the record notifying portion 101 may send the job record data 6R only for a specific type of job which involves printing such as copying or network printing.

[Processing for Cloud Printing]

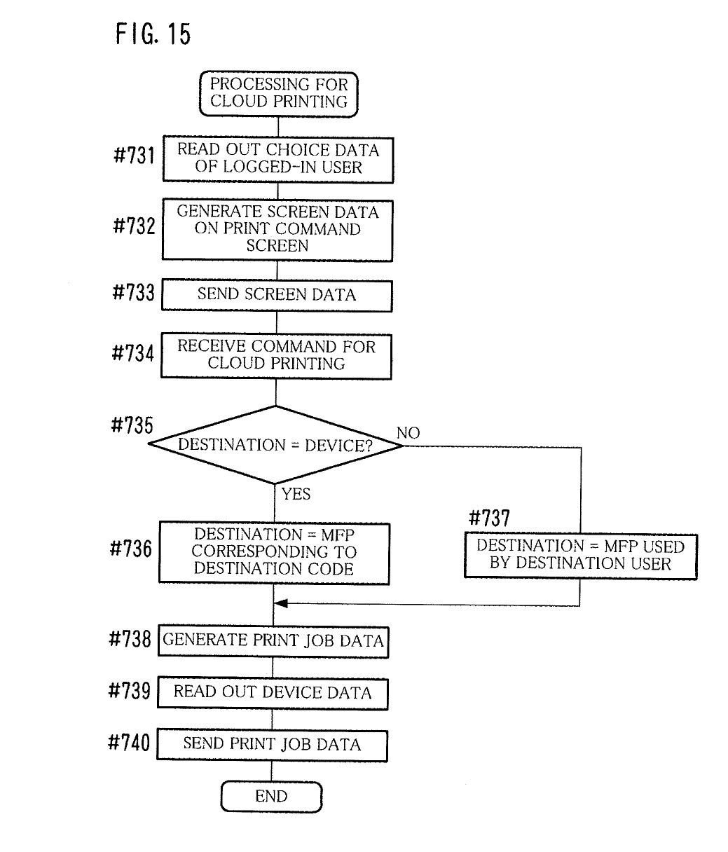

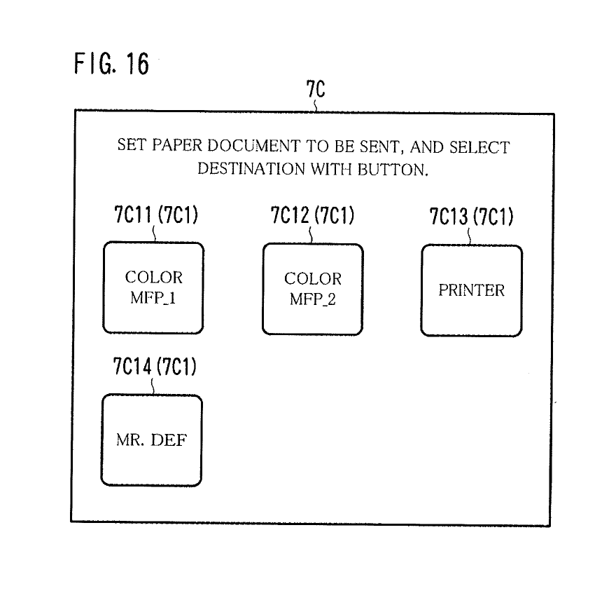

FIG. 15 is a flowchart depicting an example of the flow of processing for cloud printing. FIG. 16 is a diagram showing an example of a print command page 7C.

The description goes on to the processing by the individual devices for cloud printing. In the print server 2A, the print command receiving portion 232, the printing device determination portion 233, and the print job instructing portion 234 perform the processing in the steps depicted in FIG. 15.

The user operates any one of the image forming apparatuses 1 to log into the print server 2A via the web browser to enter a URL of a web page for cloud printing. Hereinafter, an example is described in which the user (logged-in user) operates the image forming apparatus 1A1.

With the print server 2A, in response to the URL entered, the print command receiving portion 232 performs processing for receiving a command for cloud printing in the following manner.

The print command receiving portion 232 reads out the choice data 6G indicating, as the “user code”, the user code of the logged-in user from the destination choice data storage portion 203 (Step #731 of FIG. 15). The print command receiving portion 232 then generates screen data 6S for displaying the print command page 7C shown in FIG. 16 as a web page (Step #732), and sends the screen data 6S to the image forming apparatus 1A1 (Step #733).

The print command page 7C has buttons 7C1 corresponding to choice codes indicated in the choice data 6G thus read out. For example, where a user given the user code “U1001” is the logged-in user, and choice data 6G1, 6G2, 6G3, and 6G6 are read out as the choice data 6G, buttons 7C11-7C14 are provided as the buttons 7C1 corresponding to the choice codes “A0001”, “A0002”, “A0003”, and “A0006”.

The image forming apparatus 1A1 receives the screen data 6S to display the print command page 7C.

The user places paper on which a document to be sent is depicted on the scanner unit 10i. The user then selects the button 7C1 corresponding to the destination of the document.

In response to the selection, the image forming apparatus 1A1 generates image data 6T on the document by scanning the paper, and generates transmission destination specifying data 6U showing a choice code corresponding to the selected button 7C1. The image forming apparatus 1A then sends the image data 6T and the transmission destination specifying data 6U to the print server 2A.

The print command receiving portion 232 receives a command for cloud printing by receiving the image data 6T and the transmission destination specifying data 6U (Step #734).

The printing device determination portion 233 determines, based on the transmission destination specifying data 6U, the image forming apparatus 1 which is to print the document shown in the image data 6T in the following manner. The image forming apparatus 1 to print the document is hereinafter described as a “print executing device”.

Where the choice data 6G indicating the choice code shown in the transmission destination specifying data 6U contains a destination device code (YES in Step #735), the printing device determination portion 233 determines that the print executing device is the image forming apparatus 1 corresponding to the destination device code (Step #736).

On the other hand, where the choice data 6G contains a destination user code (NO in Step #735), the printing device determination portion 233 determines the print executing device based on the login record data 6Q or the job record data 6R, for example, in the following manner (Step #737).

The printing device determination portion 233 searches in the login record table 7T1 (see FIG. 14A) for the login record data 6Q indicating the destination user code as the “user code”. The printing device determination portion 233 then determines that the print executing device is the image forming apparatus 1 whose device code is indicated in the login record data 6Q found out by the search. If a plurality of sets of such login record data 6Q is found out, then the printing device determination portion 233 determines that the print executing device is the image forming apparatus 1 whose device code is indicated in the login record data 6Q having the latest login date and time. Alternatively, if a plurality of sets of such login record data 6Q is found out, then the printing device determination portion 233 may determine that the print executing device is the image forming apparatus 1 whose device code is indicated most in the sets of login record data 6Q.

Alternatively, the printing device determination portion 233 searches in the job record table 7T2 (see FIG. 14B) for the job record data 6R indicating the destination user code as the “user code”. The printing device determination portion 233 then determines that the print executing device is the image forming apparatus 1 whose device code is indicated in the job record data 6R found out by the search. If a plurality of sets of such job record data 6R is found out, then the printing device determination portion 233 determines that the print executing device is the image forming apparatus 1 whose device code is indicated in the job record data 6R having the latest login date and time. Alternatively, if a plurality of sets of such job record data 6R is found out, then the printing device determination portion 233 may determine that the print executing device is the image forming apparatus 1 whose device code is indicated most in the sets of job record data 6R.

The print job instructing portion 234 generates print job data 6V for executing a print job (Step #738). The print job data 6V can be generated by using a known method of converting the image data 6T to a page description language corresponding to the print executing device, for example.

The print job instructing portion 234 then reads out the device data 6F (see FIG. 8) on the print executing device from the device data storage portion 202 (Step #739), and sends the print job data 6V to the print executing device based on the gateway address, the self-IP address, or the MAC address indicated in the device data 6F (Step #740). In this way, the print executing device is instructed to execute the print job.

The image forming apparatus 1, which is the print executing device, receives the print job data 6V and performs print processing based on the print job data 6V. Thereby, the document is printed onto the paper.

The print job instructing portion 234 may add, to the print job data 6V, information on the user who is the transmission source. For example, the print job instructing portion 234 may add, to the header or the footer of the document, the name of the user and the organization name of the organization which the user is in, and then generate the print job data 6V.

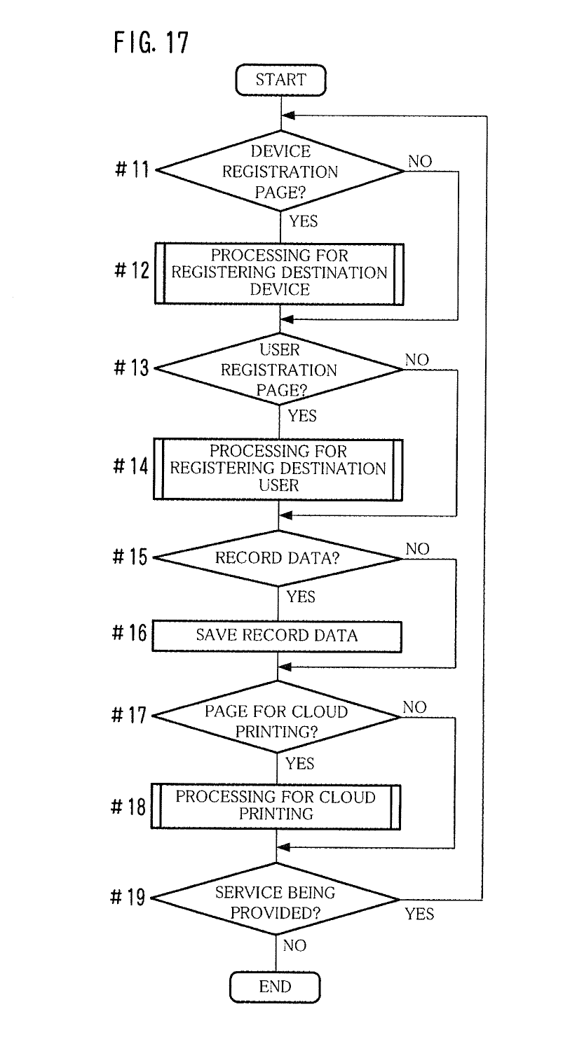

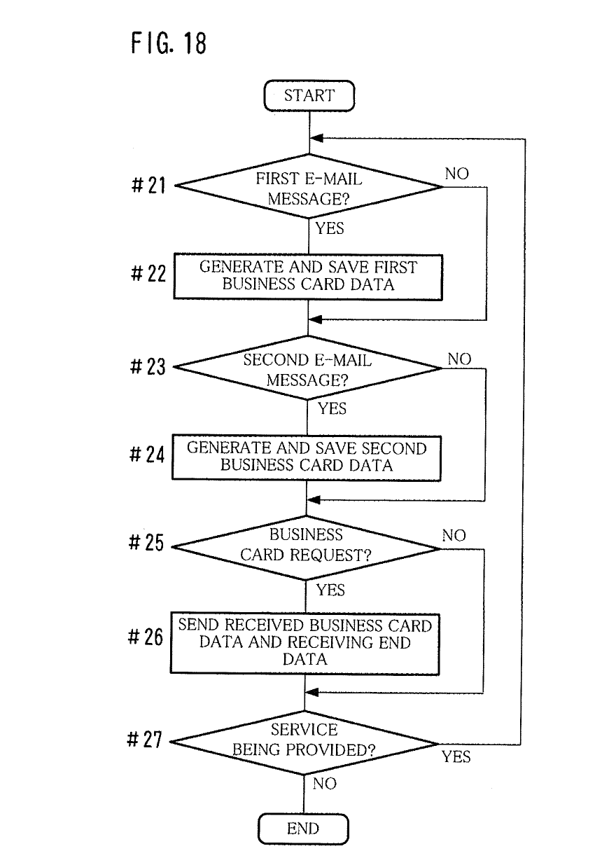

FIG. 17 is a flowchart depicting an example of the flow of the entire processing based on the cloud print program 20P. FIG. 18 is a flowchart depicting an example of the flow of the entire processing based on the business card management program 21P.

The description goes on to the flow of the entire processing by the print server 2A and the business card management server 2B. The description is provided with reference to the flowcharts.

The print server 2A performs the processing based on the cloud print program 20P in the steps depicted in FIG. 17.

When the user uses a web browser of a tablet computer or the like to log into the print server 2A to make a request for the registration web page 7A (YES in Step #11 of FIG. 17), the print server 2A performs processing for registering the image forming apparatus 1 as a destination (Step #12). The processing steps are depicted earlier with reference to FIG. 10.

After the login, when the registration web page 7B is requested (YES in Step #13), the print server 2A performs processing for registering another user as a destination (Step #14). The processing steps are depicted earlier with reference to FIG. 12.

When receiving the login record data 6Q or the job record data 6R (YES in Step #15), the print server 2A stores the login record data 6Q into the login record table 7T1 (see FIG. 14A), or, stores the job record data 6R into the job record table 7T2 (see FIG. 14B)(Step #16).

After the login, when the web page for cloud printing is accessed (Yes in Step #17), the print server 2A performs the processing for cloud printing (Step #18). The processing steps are depicted earlier with reference to FIG. 15.

While providing the cloud printing service (YES in Step #19), the print server 2A performs the processing of Step #12, the processing of Step #14, the processing of Step #16, and the processing of Step #18 appropriately.

The business card management server 2B performs the processing based on the business card management program 21P in the steps depicted in FIG. 18.

When receiving the first electronic mail message 6C1 (YES in Step #21 of FIG. 18), the business card management server 2B generates first business card data 6A based on the first electronic mail message 6C1 and so on to store the first business card data 6A (Step #22).

When receiving the second electronic mail message 6C2 (YES in Step #23), the business card management server 2B generates second business card data 6D based on the second electronic mail message 6C2 and so on to store the second business card data 6D (Step #24).

When receiving the business card request data 6K from the print server 2A (YES in Step #25), the business card management server 2B sends the received business card data 6L and the receiving end data 6M to the print server 2A (Step #26).

While providing the business card data management service (YES in Step #27), the business card management server 2B performs the processing of Step #22, the processing of Step #24, and the processing of Step #26 appropriately.

According to this embodiment, where a user of an organization and a user of another organization have ever exchanged their business cards with each other, the image forming apparatus 1 of the former organization is capable of causing the image forming apparatus 1 of the latter organization to print a document. It is thus possible to prevent the image forming apparatus 1 of the former organization from printing an unnecessary document given by the latter organization more reliably than is conventionally possible.

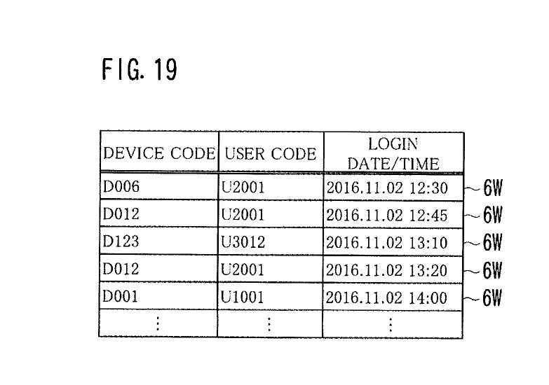

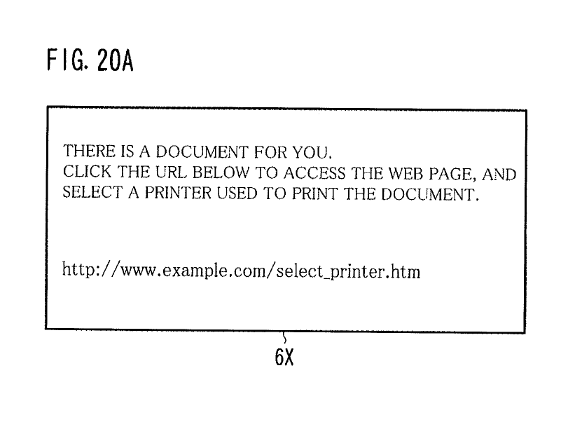

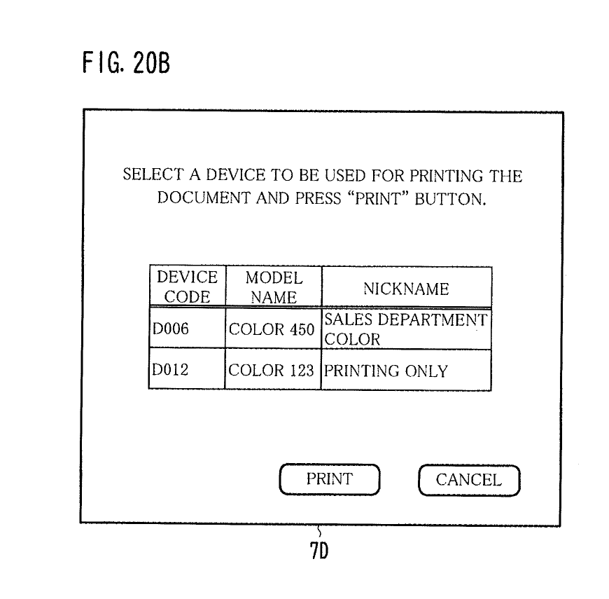

FIG. 19 is a diagram showing an example of transmission log data 6W. FIGS. 20A and 20B are diagrams showing an example of an electronic mail message 6X and a selection page 7D.

In this embodiment, the printing device determination portion 233 determines a print executing device based on the login record data 6Q or the job record data 6R. Instead of this, however, the method described below may be used for the determination.

Every time sending the print job data 6V to the print executing device, the print job instructing portion 234 generates transmission log data 6W as that shown in FIG. 19 to save the transmission log data 6W to a database. The transmission log data 6W indicates a device code of the print executing device, a user code corresponding to the button 7C1 (see FIG. 16) selected by the user, and a date and time at which the print job data 6V is sent (transmission date and time). Where a code corresponding to the button 7C1 is a device code, the transmission log data 6W is not saved.

The printing device determination portion 233 receives the image data 6T and the transmission destination specifying data 6U. Where the choice data 6G showing the choice code indicated in the transmission destination specifying data 6U indicates a destination user code, the printing device determination portion 233 searches in the database for the transmission log data 6W indicating, as the “user code”, the destination user code.

The printing device determination portion 233 determines that the print executing device is the image forming apparatus 1 corresponding to the device code indicated in the transmission log data 6W. Stated differently, the printing device determination portion 233 determines that the print executing device is the image forming apparatus 1 which has been used to receive a document by the destination user regardless of who is the transmission source user.

If a plurality of sets of such transmission log data 6W is found out, then the printing device determination portion 233 preferably determines that the print executing device is the image forming apparatus 1 given the device code indicated in the transmission log data 6W having the latest transmission date and time. Alternatively, if a plurality of sets of such transmission log data 6W is found out, then the printing device determination portion 233 preferably determines that the print executing device is the image forming apparatus 1 given the device code indicated most.

Alternatively, if a plurality of sets of the login record data 6Q, of the job record data 6R, or of the transmission log data 6W indicating the destination user code are found out, and further, if the device codes indicated therein are not the same as one another, then the printing device determination portion 233 may present, to the user corresponding to the destination user code (destination user), the image forming apparatuses 1 corresponding to the device codes indicated in the plurality of sets of data may be shown to the user to cause him/her to select the image forming apparatus 1 to be used as the print executing device.

For example, the printing device determination portion 233 creates the electronic mail message 6X as that shown in FIG. 20A to send the same to an electronic mail address of the destination user. The electronic mail message 6X contains a message informing the destination user that there is a document to be received by him/her and a URL of a web page in which to select the image forming apparatus 1. The electronic mail address of the destination user is indicated in the second business card data 6D on the destination user. The destination user receives the electronic mail message 6X in a terminal such as his/her smartphone to select the URL through click or the like. In response to the operation, the terminal accesses the print server 2A based on the URL.

The printing device determination portion 233 then generates data for displaying the selection page 7D as that shown in FIG. 20B as a web page to send the generated data to the terminal. The terminal displays the selection page 7D. The selection page 7D shows the foregoing device codes, model names and nicknames of the image forming apparatuses 1 corresponding to the device codes. The model names and the nicknames are the same as those indicated in the device data 6F (see FIG. 8).

The destination user selects a device code of the image forming apparatus 1 to be set as the print executing device and presses a “print” button. In response to the user operation, the terminal informs the print server 2A of the selected device code.

The printing device determination portion 233 determines that the print executing device is the image forming apparatus 1 corresponding to the informed device code.

Alternatively, the printing device determination portion 233 waits for the destination user to log into the print server 2A. When the destination user logs into the print server 2A, the printing device determination portion 233 causes the web browser used by the destination user to display the selection page 7D. Alternatively, when the destination user logs into the image forming apparatus 1, the image forming apparatus 1 informs the print server 2 that the destination user has logged into the image forming apparatus 1. The printing device determination portion 233 then causes the web browser of the image forming apparatus 1 to display the selection page 7D.

The destination user selects a device code of the image forming apparatus 1 to be set as the print executing device. The web browser then informs the print server 2A of the selected device code. The printing device determination portion 233 then determines that the print executing device is the image forming apparatus 1 corresponding to the informed device code.

In this embodiment, the contactable party determination portion 206 determines that a person who has exchanged his/her business card with the logged-in user is a contactable person. Instead of this, however, the determination may be made by any one of the following two methods.

The first method is described first. The first method involves using a Social Networking Service (SNS) such as Facebook. The business card data storage portion 241 stores, instead of the second business card data 6D of each user, data indicating an URL of a web page in which a user code of each user, a user identifier and a friend of each user in the SNS are displayed. Such data is hereinafter referred to as “SNS data”. In such a case, the first business card data 6A is unnecessary.

The business card data obtaining portion 205 receives the SNS data on the logged-in user from the business card management server 2B. The business card data obtaining portion 205 then accesses the web page based on the URL indicated in the SNS data to obtain an identifier of a friend of the logged-in user. The business card data obtaining portion 205 searches in the business card data storage portion 241 for SNS data indicating the obtained identifier.

The contactable party determination portion 206 determines that a person corresponding to the user code indicated in the SNS found out is a contactable person.

In some cases, the user discloses his/her friends to some of users only. In other cases, the user does not disclose his/her friends. In such cases, the contactable party determination portion 206 preferably obtains in advance a permission to access the SNS by OAuth and Single Sign On (SSO) techniques, accesses a page of the user to obtain information on the user.

The description goes on to the second method. The second method involves using data on records of confidential fax.

The “confidential fax” is a function to save data to a particular storage area (box or folder, for example) and print a document in response to specific operation (password entry, for example) performed, instead of printing a document immediately after a receiving device receives fax data.

The user logs into the image forming apparatus 1 to enter, as conditions for the confidential fax, an identifier of a storage area into which to store data and a fax number of the destination. The user has to be informed of the identifier of the storage area usually by a person as the destination. Thus, the truth that the user can enter the identifier of the storage area of the person means that the person as the destination approves the user as a person concerned.

The image forming apparatus 1 sends the data based on the entered conditions via the confidential fax in a conventional way.

The image forming apparatus 1 further sends record data indicating the transmission record to the print server 2A. The record data indicates the user code of the user (namely, the user who has given the command for confidential fax), the fax number of the destination, and the identifier of the storage area.

The print server 2A receives the record data to store the record data into the database. The print server 2A stores, in advance, fax numbers of the organizations. The print server 2A further stores, in advance, for each of the storage areas for confidential fax provided in the individual image forming apparatuses 1, the user codes of the users thereof and the identifiers of the storage areas in correlation with one another.

When a certain user logs into the print server 2A to access a web page for registering another user as the destination, the contactable party determination portion 206 searches in the database for record data indicating the user code of the user (logged-in user). The contactable party determination portion 206 identifies an organization having a fax number indicated in the record data found out by the search. The contactable party determination portion 206 identifies a user code of a user having a storage area corresponding to the identifier indicated in the record data found out by the search. The contactable party determination portion 206 then determines that the user given the identified user code is a contactable person.

In this embodiment, the second destination data registration portion 207 correlates the logged-in user with a contactable person based on the choice data 6G without checking with the contactable person. Instead of this, however, the second destination data registration portion 207 may inquire the contactable person via electronic mail whether it is possible to correlate the logged-in user with the contactable person. The second destination data registration portion 207 then may correlate the logged-in user with the contactable person only when the contactable person permits such correlation. Further, the second destination data registration portion 207 may make such an inquiry also to the logged-in user to perform such correlation processing only when the logged-in user permits such correlation.

In this embodiment, the image forming apparatus 1 is used as a device for sending a document. Instead of this, a terminal such as a personal computer, a tablet computer, or a smartphone may be used as the device for sending a document.

In such a case, the user prepares document data by creating a document with an application such as a word-processing program, a spreadsheet program, or a drawing program. The user then designates a destination.

In response to the user operation, the terminal sends document data as the image data 6T to the print server 2A, and sends data indicating a choice code of the designated destination, as the transmission destination specifying data 6U, to the print server 2A.

In response to a request from the user, it is possible to delete the first business card data 6A indicating a user code of the user from the business card data storage portion 241.

Before sending the print job data 6V, the print job instructing portion 234 may determine whether or not the logged-in user and the contactable person selected are correlated with each other based on the latest first business card data 6A stored in the business card data storage portion 241. The method for determination is the same as that for determination by the contactable party determination portion 206. If the logged-in user and the contactable person selected are correlated with each other, then the print job instructing portion 234 preferably sends the print job data 6V. Otherwise, the print job instructing portion 234 preferably cancels sending the print job data 6V. The same processing may be applied also to the case of using an SNS for confirmation of correlation.

It is also possible to provide a deletion portion in the print server 2. The deletion portion serves to delete, from the destination choice data storage portion 203, the choice data 6G which is to correlate the contactable person with the logged-in user when the correlation therebetween is cancelled. The deletion portion may delete the choice data 6G in response to a request from a user corresponding to a destination user code indicated in the choice data 6G.

It is to be understood that the configurations of the document delivery system 5, the image forming apparatus 1, the print server 2A, and the business card management server 2B, the constituent elements thereof, the content and order of the processing, the configuration of data, the configuration of screen, and the like can be appropriately modified without departing from the spirit of the present invention.

It is to be understood that the overall configuration of the image forming apparatus 1 and the motor controller 21, the constituent elements thereof, the content of the processing, the order of the processing, the time of the processing, the structure of the brushless motors 3 and 3B, and the like may be appropriately modified without departing from the spirit of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A print relay server for performing processing for causing one or more image forming apparatuses to print a document sent by a transmission device, said one or more image forming apparatuses being located in a second organization which a second person is in, the transmission device being located in a first organization which a first person is in and being operated by the first person, the print relay server comprising:
a hardware processor; and
a communication unit; wherein
the communication unit receives the document from the transmission device, and
where the first person and the second person are correlated with each other, the hardware processor causes the communication unit to send command data indicating a command to print the document to, among said one or more image forming apparatuses, a destination image forming apparatus used by the second person.

2. The print relay server according to claim 1, wherein the hardware processor causes the communication unit to send the command data by using as the destination image forming apparatus, among said one or more image forming apparatuses, the image forming apparatus having been used most frequently by the second person.

3. The print relay server according to claim 1, wherein the hardware processor causes the communication unit to send the command data by using as the destination image forming apparatus, among said one or more image forming apparatuses, the image forming apparatus having been logged in or used for printing most recently by the second person.

4. The print relay server according to claim 1, wherein
after the communication unit receives the document, the hardware processor causes the communication unit to send request data for requesting the second person to select the destination image forming apparatus, and
the hardware processor causes the communication unit to send the command data by using as the destination image forming apparatus, among said one or more image forming apparatuses, the image forming apparatus selected by the second person.

5. The print relay server according to claim 4, wherein the hardware processor causes the communication unit to send, as the request data, an electronic mail message containing a URL of a web page in which to select the destination image forming apparatus to a terminal of the second person.

6. The print relay server according to claim 1, wherein the hardware processor causes the communication unit to send display request data for requesting to display a web page in which to select the destination image forming apparatus to the image forming apparatus operated for login by the second person among said one or more image forming apparatuses.

7. The print relay server according to claim 1, wherein, where the first person permits to be correlated with the second person and the second person permits to be correlated with the first person, the hardware processor determines that the first person and the second person are correlated with each other and causes the communication unit to send the command data.

8. The print relay server according to claim 1, wherein, where the first person stores a business card of the second person into a specific storage portion and the second person stores a business card of the first person in the storage portion, the hardware processor determines that the first person and the second person are correlated with each other and causes the communication unit to send the command data.

9. The print relay server according to claim 1, wherein, where the first person has ever used a function of confidential fax to send another document to a storage region of the second person, the hardware processor determines that the first person and the second person are correlated with each other and causes the communication unit to send the command data.

10. The print relay server according to claim 1, wherein, where the first person and the second person are in a friend relationship in a Social Networking Service (SNS), the hardware processor determines that the first person and the second person are correlated with each other and causes the communication unit to send the command data.

11. The print relay server according to claim 1, comprising a storage configured to store correlation data therein, the correlation data showing that the first person and the second person are correlated with each other; wherein
the hardware processor deletes the correlation data from the storage based on a request by the second person, and
where the storage stores the correlation data, the hardware processor determines that the first person and the second person are correlated with each other and causes the communication unit to send the command data.

12. A method for giving a print command for causing one or more image forming apparatuses to print a document sent by a transmission device, said one or more image forming apparatuses being located in a second organization which a second person is in, the transmission device being located in a first organization which a first person is in and being operated by the first person, the method comprising:
receiving the document from the transmission device; and
giving a command, where the first person and the second person are correlated with each other, to print the document to, among said one or more image forming apparatuses, a destination image forming apparatus used by the second person.

13. A non-transitory recording medium for storing a computer readable program used in a computer, the computer performing processing for causing one or more image forming apparatuses to print a document sent by a transmission device, said one or more image forming apparatuses being located in a second organization which a second person is in, the transmission device being located in a first organization which a first person is in and being operated by the first person, the computer readable program controlling the computer to execute processing comprising:
receiving processing for receiving the document from the transmission device; and
command processing for giving a command, where the first person and the second person are correlated with each other, to print the document to, among said one or more image forming apparatuses, a destination image forming apparatus used by the second person.

14. The non-transitory recording medium according to claim 13, wherein the command processing is processing for giving a command to print the document to the destination image forming apparatus by using as the destination image forming apparatus, among said one or more image forming apparatuses, the image forming apparatus having been used most frequently by the second person.

15. The non-transitory recording medium according to claim 13, wherein the command processing is processing for giving a command to the destination image forming apparatus by using as the destination image forming apparatus, among said one or more image forming apparatuses, the image forming apparatus having been logged in or used for printing most recently by the second person.

16. The non-transitory recording medium according to claim 13, wherein
after the document is received, the computer readable program controls the computer to execute request processing for requesting the second person to select the destination image forming apparatus, and
the command processing is processing for giving a command to print the document to the destination image forming apparatus by using as the destination image forming apparatus, among said one or more image forming apparatuses, with the image forming apparatus selected by the second person.

17. The non-transitory recording medium according to claim 15, wherein the request processing is processing for requesting to select the destination image forming apparatus by sending an electronic mail message containing a URL of a web page in which to select the destination image forming apparatus to a terminal of the second person.

18. The non-transitory recording medium according to claim 15, wherein the request processing is processing for requesting to select the destination image forming apparatus by instructing the image forming apparatus operated for login by the second person among said one or more image forming apparatuses to display a web page in which to select the destination image forming apparatus.

19. The non-transitory recording medium according to claim 13, wherein the command processing is processing for giving, where the first person permits to be correlated with the second person and the second person permits to be correlated with the first person, a command to print the document to the destination image forming apparatus by determining that the first person and the second person are correlated with each other.

20. The non-transitory recording medium according to claim 13, wherein the command processing is processing for giving, where the first person stores a business card of the second person into a specific storage portion and the second person stores a business card of the first person in the storage portion, a command to print the document to the destination image forming apparatus by determining that the first person and the second person are correlated with each other.

21. The non-transitory recording medium according to claim 13, wherein the command processing is processing for giving, where the first person has ever used a function of confidential fax to send another document to a storage region of the second person, a command to print the document to the destination image forming apparatus by determining that the first person and the second person are correlated with each other.

22. The non-transitory recording medium according to claim 13, wherein the command processing is processing for giving, where the first person and the second person are in a friend relationship in a Social Networking Service (SNS), a command to print the document to the destination image forming apparatus by determining that the first person and the second person are correlated with each other.

23. The non-transitory recording medium according to claim 13, wherein
the computer is capable of accessing a storage for storing, therein, correlation data showing that the first person and the second person are correlated with each other,
the computer readable program controls the computer to execute deletion processing for deleting the correlation data from the storage based on a request by the second person, and
the command processing is processing for giving, where the correlation data storage portion stores the correlation data, a command to print the document to the destination image forming apparatus by determining that the first person and the second person are correlated with each other.
